(19) United States
(12) Patent Application Publication
(10) Pub. No.: US 2015/0286632 A1
(43) Pub. Date: Oct. 8, 2015

(54) PREDICTING THE QUALITY OF AUTOMATIC TRANSLATION OF AN ENTIRE DOCUMENT

(71) Applicant: Xerox Corporation, Norwalk, CT (US)

(72) Inventor: Jean-Luc Meunier, Saint-Nazaire-Ies-Eymes (FR)

(73) Assignee: Xerox Corporation, Norwalk, CT (US)

(21) Appl. No.: 14/244,385

(22) Filed: Apr. 3, 2014

(51) Int. Cl. G06F 17/28

(52) U.S. Cl. CPC G06F 17/289

(57) ABSTRACT

A system and a method for predicting the translation quality of a document are provided. The method includes receiving a translation quality estimate for each of a plurality of sentences of an input document which have been translated from a source language to a target language using machine translation. The translation quality of the translated input document is predicted based on the translation quality estimate for each of the sentences and parameters of a model learned using translation quality estimates for sentences of training documents and respective manually-applied translation quality values. The parameters of the model may include an exponent for an aggregating function and a set of weights, each of the weights being mapped to a respective one of a predefined set of translation quality estimates for weighting the translation quality estimates in the aggregating function.

### BACKGROUND

The exemplary embodiment relates to machine translation and finds particular application in connection with a system and method for predicting the quality of automatic translation of a whole document.

Automated translation, also called machine translation (MT), is concerned with the automatic translating a textual document from a source language to a target language. Statistical Machine Translation (SMT) is a common approach and in a phrase-based method entails, for each source sentence, drawing biphrases (source-target phrase pairs) from a biphrase library to cover the sentence. The candidate translation is then scored with a scoring function which takes into account probabilities of occurrence, in a parallel corpus, of the biphrases which were used. Other SMT systems are based on the translation of syntactic units, using partial parse trees. Although the quality of SMT is usually lower than what a professional human translator can achieve, it is valuable in many business applications.

To cope with translation errors in automated translation, translation quality estimation methods have been developed to predict the quality of the translation independently of the translation process itself. Such methods include Confidence Estimation (CE) and Quality Prediction (QP). See, for example, Blatz, et al., “Confidence Estimation for Machine Translation,” Proc. 20th Intern'l Conf. on Computational Linguistics Article No. 315 (2004), hereinafter, “Blatz 2004”; Specia, et al., “Estimating the sentence-level quality of machine translation,” 13th Annual Conf. of the European Association for Machine Translation (EAMT), pp. 28-37 (2009), hereinafter, “Specia 2009.” While the quality and confidence approaches differ slightly from each other, from a practical applicative perspective, their computation and usage is generally the same. The quality estimation is often cast as a multi-class classification problem or as a regression problem. First, a training set is generated by human evaluation of the quality of translation of a textual dataset at the sentence level. Then a classifier (or regressor) is learnt in order to predict a score for a new translation. Often, a coarse grained scale is used for labeling the training data, since the evaluation of the quality of a translation is so subjective, as evidenced by the low level of agreement among multiple human evaluators. In some cases, the labels can be integers from 1-4, with 4 indicating highest quality and 1, the lowest. Often, a binary classifier suffices because in a typical business context, the goal is simply to decide whether to trust the machine translation or not. In some approaches, two dimensions are evaluated separately, such as fluency (of the output text) and adequacy (of its content with respect to the input text). If the score is below a threshold quality (or 0 in the binary case), a manual translation of the input text is obtained, generally from a person who is fluent in the two languages.

Machine translation quality predictors are sometimes built as a statistical model operating on a feature set obtained from both the input and output texts (black box features) as well as from information from the inner functioning of the SMT system (glass box features). See, for example, Specia, et al., “Improving the Confidence of Machine Translation Quality Estimates,” Proc. MT Summit XII (2009).

One problem with existing quality predictors is that an SMT system works at the sentence-level, so quality estimation is performed on each sentence. It is therefore difficult to estimate the quality of an entire document, which may be composed of a number of sentences. Often, it is a document-level quality estimate which is needed.

There remains a need for a system and method which are able to estimate the quality of translation of a document composed of a series of sentences that were translated individually.

### BRIEF DESCRIPTION

In accordance with one aspect of the exemplary embodiment, a method for predicting the translation quality of a document includes receiving a translation quality estimate for each of a plurality of sentences of an input document which have been translated from a source language to a target language using machine translation. With a processor, the translation quality of the translated input document is predicted, based on the translation quality estimate for each of the sentences and parameters of a model learned using translation quality estimates for sentences of training documents and respective manually-applied translation quality values.

In accordance with another aspect of the exemplary embodiment, a system for predicting the translation quality of a document includes a machine translation component for translating sentences of an input document from a source language to a target language. A quality estimation component estimates translation quality of each of the translated sentences. A prediction component predicts the translation quality of the translated document based on the translation quality estimates for the sentences and parameters of a model learned using translation quality estimates for sentences of training documents and respective manually-applied translation quality values. A processor implements the machine translation component, quality estimation component, and prediction component.

In accordance with another aspect of the exemplary embodiment, a method for predicting the translation quality of a document includes receiving an input document in a source language comprising a plurality of sentences, translating the sentences of the input document from the source language to a target language to generate a translated document, estimating a translation quality of each of the translated sentences in the translated document, and predicting the translation quality of the translated document. The prediction is based on the translation quality estimates for the translated sentences, and includes computing an aggregating function for which translation quality estimates are weighted with weights wherein the weights and an exponent for the aggregating function have been learned using translation quality estimates for sentences of training documents and a respective manually-applied translation quality value of the training document.

One or more steps of the method may be performed with a processor.

### BRIEF DESCRIPTION OF THE DRAWINGS

FIG. 1 is a functional block diagram of a quality estimation system in accordance with one aspect of the exemplary embodiment;

FIG. 2 is a flow chart illustrating a translation quality estimation method in accordance with one aspect of the exemplary embodiment;

FIG. 3 is a flow chart illustrating learning an aggregating function for use in the quality estimation method of FIG. 2;

FIGS. 4 and 5 illustrate fluency and adequacy scores for Swedish-English and English-Swedish translations; and

FIGS. 6 and 7 illustrate the similarity of the fluency and adequacy scores for English-Swedish and Swedish-English translations.

### DETAILED DESCRIPTION

Aspects of the exemplary embodiment relate to a system and method for predicting the overall translation quality of a translated document composed of a sequence of sentence translations, based on translation quality estimates for the sentence translations. In particular, model parameters are learned for use in predicting the translation quality of a document of variable length (in terms of number of sentences) using annotated training documents and sentence-level translation quality estimates. In one embodiment, the model parameters include weights and an exponent for an aggregating function which aggregates the sentence quality estimates. In another embodiment, the model is a classifier model which predicts the document translation quality based on translation quality estimate-based features.

The method finds use in a variety of applications. As an example, a customer care agent for a business communicates, e.g., via a web browser or email, with a customer who speaks a different language. The customer care agent wishes to have his responses translated quickly to the customer's language, but would like the message translations to be of good quality as a whole, so that they are not confusing to the customer or present a poor image of the business. Additionally, the agent would like the customer's messages to be translated to the agent's own language. The exemplary system and method can be used for analysis of the translated messages sent in both directions, optionally with different thresholds on the message-level translation quality. The method is useful when no reference (human) translation is yet available, as is the case in the exchange of messages between a customer and an agent.

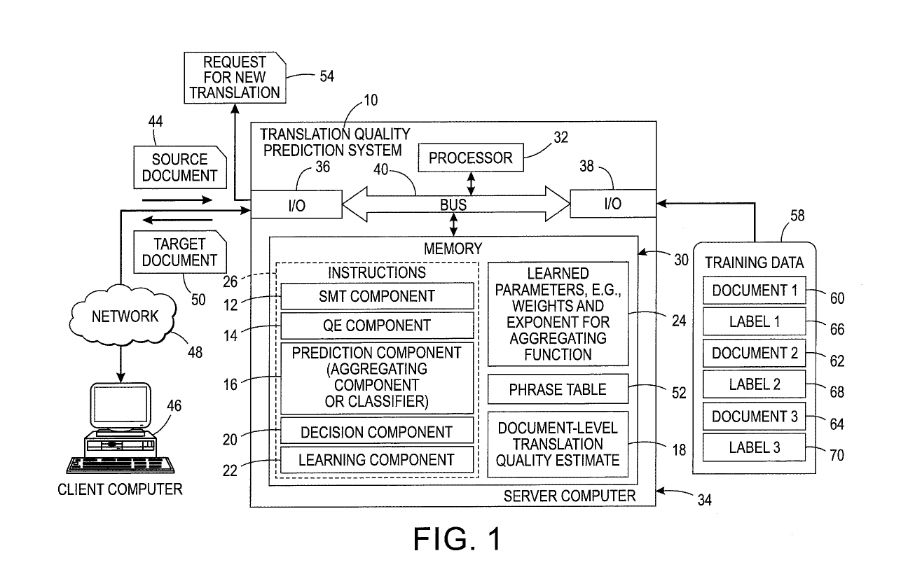

With reference to FIG. 1, a system 10 for evaluating the quality of machine translation of a document, such as a message is shown. The system includes or has access to a statistical machine translation (SMT) component 12, which translates text from a source natural language to a target natural language, different from the source language. As will be appreciated, more than one SMT component 12 may be provided, allowing the system to select from the different translations output from them. A quality estimation (QE) component 14 computes sentence-level translation quality estimates using, for example, a CE function or other quality estimation function. The exemplary QE component works at the sentence level outputting scores on a certain pre-defined scale, e.g., an ordinal scale with a set of K predefined values. An integer scale of 1-K, where K is, for example, from 2 to 8 can be used, where higher values indicate better estimated translation quality. K=4 in an example embodiment. In another embodiment K=2 (where the values can be 1 and 2). The sentence-level quality estimates output by the QE component 14 are referred to herein as SQEs. Each sentence's SQE is evaluated independently of the translation quality of the other sentences in the message. Thus, each sentence can have the same or a different score from the other sentences of a message.

A prediction component 16 generates a document-level translation quality estimate (DQE) 18 for the entire translated document, based on the sentence SQE for each of the sentences which make up the document. In one embodiment, the prediction component includes an aggregating component which aggregates the SQEs for a plurality of sentences received from the QE component 14 and outputs the document-level translation quality estimate 18. In another embodiment, the prediction component includes a classifier which predicts the DQE based on SQE-based features. The message-level quality estimate 18 can be used by a decision component 20 to evaluate whether the translation is adequate for the task, e.g., whether DQE 18 meets a predefined threshold, or whether a new translation (machine or human) should be obtained.

As used herein a “document” can be any body of text which includes a plurality of sentences in a natural language with a grammar and a vocabulary, such as English or French. In general, the input document is fairly short, such as up to a paragraph or two in length, e.g., on average, about 2-20 or 2-10 sentences in length, such as a message being sent between a customer and an agent or vice versa. For larger documents, the document may be split into sub-parts, e.g., paragraphs, and analyzed first at the paragraph level and then an overall document DQE computed based thereon.

In one embodiment, in a training phase, a learning component 22 learns parameters 24 used by the prediction component 16. In one embodiment, the parameters include weights and an exponent for an aggregating function to be employed by the aggregating component 16, using manually labeled training samples. In another embodiment the learning component 22 learns parameters of a classifier model, such as a linear classifier, based on manually labeled training samples.

Components 12, 14, 16, 20, and 22 may be software components forming a set of instructions 26 for performing the method described below, which are stored in memory 30 of the system. A processor 32, in communication with the memory 30 executes the instructions 26. The system 10 may be embodied in one or more computing devices, such as the illustrated server computer 34. One or more input/output (I/O) interfaces 36, 38 allow the system to communicate with external devices. Hardware components 30, 32, 36, 38 of the system communicate via a data/control bus 40.

The computer 34 may be a PC, such as a desktop, a laptop, palmtop computer, portable digital assistant (PDA), server computer, cellular telephone, tablet computer, pager, combination thereof, or other computing device(s) capable of executing instructions for performing the exemplary method.

The memory 30 may include any type of non-transitory computer readable medium such as random access memory (RAM), read only memory (ROM), magnetic disk or tape, optical disk, flash memory, or holographic memory. In one embodiment, the memory 30 comprises a combination of random access memory and read only memory. In some embodiments, the processor 32 and memory 30 may be combined in a single chip. The network interface 36, 38 allows the computer to communicate with other devices via a computer network, such as a local area network (LAN) or wide area network (WAN), or the internet, and may comprise a modulator/demodulator (MODEM) a router, a cable, and and/or Ethernet port.

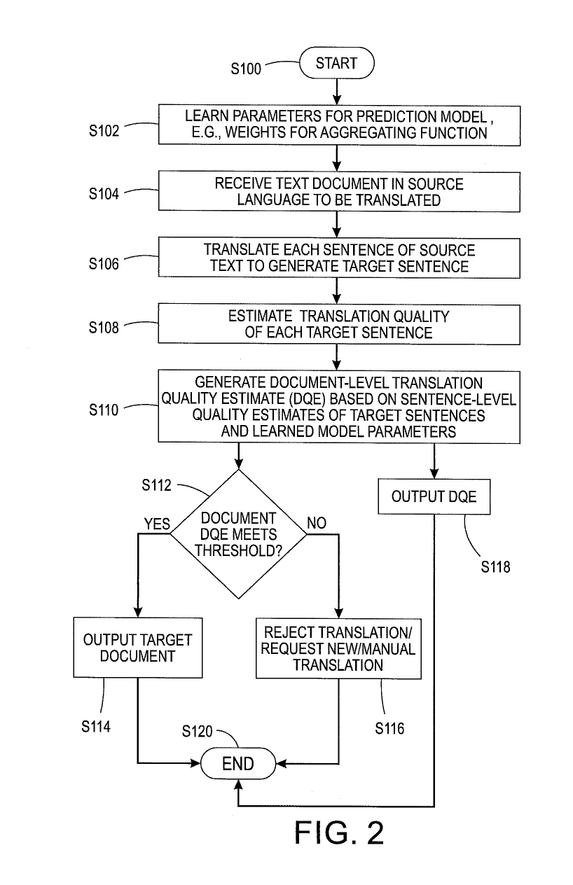

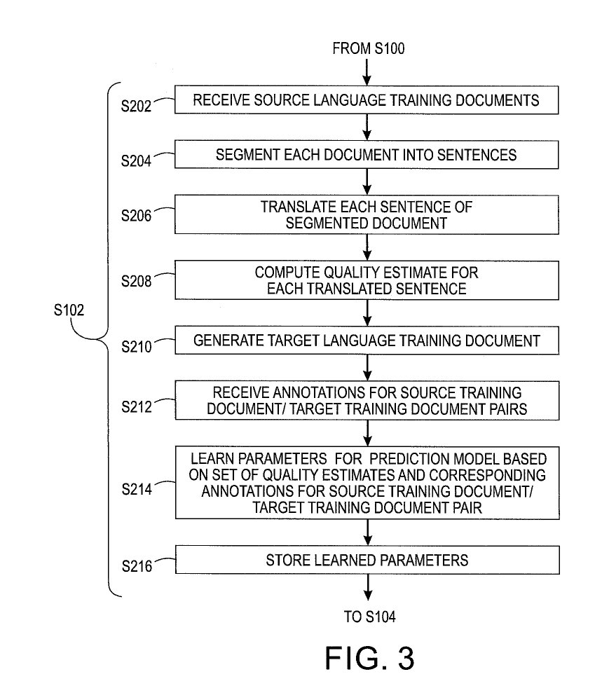

The digital processor 32 can be variously embodied, such as by a single-core processor, a dual-core processor (or more generally by a multiple-core processor), a digital processor and cooperating math coprocessor, a digital controller, or the like. The digital processor 32, in addition to controlling the operation of the computer 34, executes the instructions 26 stored in memory 30 for performing the method outlined in one or more of FIGS. 2 and 3.

The term “software,” as used herein, is intended to encompass any collection or set of instructions executable by a computer or other digital system so as to configure the computer or other digital system to perform the task that is the intent of the software. The term “software” as used herein is intended to encompass such instructions stored in storage medium such as RAM, a hard disk, optical disk, or so forth, and is also intended to encompass so-called “firmware” that is software stored on a ROM or so forth. Such software may be organized in various ways, and may include software components organized as libraries, Internet-based programs stored on a remote server or so forth, source code, interpretive code, object code, directly executable code, and so forth. It is contemplated that the software may invoke system-level code or calls to other software residing on a server or other location to perform certain functions.

FIG. 2 illustrates one embodiment of a translation method which may be performed with the system of FIG. 1. The method begins at S100.

At S102, prediction model parameters 24, such as weights and an exponent, for an aggregating function may be learned, as described below with reference to FIG. 3. Alternatively, parameters for a classifier function may be learned based on features extracted from computed sentence-level quality estimates and manually applied document-level translation quality scores.

At S104, the system 10 receives, as input, a document 44 in a source language to be translated into a target language, different from the source language. The input source-language document 44 may be received from any suitable source 46, such as a client computing device that is linked to the system 10 by a wired or wireless link 48, such as a local area network or a wide area network, such as the Internet. In other embodiments, I/O 36 is configured to receive a memory storage device, such as a disk or flash memory, on which the text is stored. In yet other embodiments, the system is wholly or partially hosted by the client device 46.

At S106, the SMT component 12 generates a machine translation (target document) 50 by segmenting the input source document 44 into sentences and separately translating each of the sentences of the document 44. In this step, a respective target language sentence is generated for each source sentence, or sometimes more than one target sentence is generated. Any suitable machine translation component may be used. In one embodiment, sentence translation is performed using biphrases drawn from a biphrase library 52. In another, partial parse trees may be used. In the exemplary machine translation process, each of a set of candidate translated sentences is scored with a translation scoring function and for each source sentence of the input document, an optimal translation (target sentence) is output, in the target language, based on the scores output by the translation scoring function for the candidate translated sentences. In some embodiments, a plurality of candidate target (multi-sentence) documents may be generated in this way using different combinations of high-scoring target sentences. Alternatively, different SMT components may be used to generate a respective translation of the input document.

At S108, the QE component 14 separately evaluates the translation quality of each sentence of the translated document output by the SMT component, based on the source sentence and corresponding target sentence, and outputs a respective sentence-level translation quality estimate (SQE) for each sentence. The SQE is output on a scale of 1-K, where K may be, for example, 4 or 5. The SQEs may be output as integer values or, if not, for purposes of later mapping to weights, may be rounded to the nearest value on that scale.

At S110, the prediction component 16 estimates the translation quality of the entire message based on the computed SQEs and learned model parameters 24. In one embodiment, the aggregating component 16 aggregates the SQEs for each of the sentences in the target document, using an aggregation function whose parameters were learned at S102, to form a document-level translation quality estimate (DQE) 18. In another embodiment, the prediction component extracts features for the document, based on the computed sentence-level quality estimates, and predicts document-level translation quality with the classifier trained at S102.

At S112, the decision component 20 determines whether the DQE 18 computed at S110 meets a preselected threshold DQE and information is output based thereon. For example, if the threshold DQE is met, then at S114 the target document 50 may be output, e.g., to the client device 46. If not, at S116, the decision component may reject the translation and may output a request 54 for a new translation. Alternatively, where a set of translations is available, e.g., from different machine translation systems 12, a different translation (which meets the threshold) may be selected for output. Or, in another embodiment, the system 10 may propose that the author of the source document reformulates the document, e.g., by using shorter sentences, more common words, and then having the document retranslated. An authoring system suited to this purpose is disclosed, for example, in U.S. application Ser. No. 13/746,034, filed Jan. 21, 2013, entitled MACHINE TRANSLATION-DRIVEN AUTHORING SYSTEM AND METHOD, by Sriram Venkatapathy, et al., the disclosure of which is incorporated herein by reference in its entirety. In other embodiments, the DQE may be output, e.g., to client computer 46, allowing an agent to decide whether the translation should be used or not.

The method ends at S120.

In one embodiment, at S102, a machine learning approach to the estimation of parameters 24 (weights and exponent) for the aggregating function is used, as illustrated in FIG. 3. As will be appreciated, a separate computing device may be used for learning the parameters of the aggregating function.

At S202, training data 58 (FIG. 1) comprising a set of representative training documents 60, 62, 64, etc. in the source language is selected, each source training document including a plurality of sentences, and is received by the system.

At S204, each source training document 60, 62, 64 is automatically segmented into sentences. The training documents can have different numbers of sentences, which may be representative of the documents for which the DQE is to be predicted, e.g., 3-10 on average.

At S206, for each training document, each sentence of the source training document is translated to generate a target sentence by the SMT component 12.

At S208, an SQE is computed for each target sentence of each translated training document by the QE component 14. Alternatively, manually applied sentence-level QE scores can be sought from one or more annotators and averaged for each sentence. The SQE is output on a scale of 1-K, where K may be, for example, 4 or 5. The SQEs may be output as integer values or, for purposes of learning a mapping to weights, may be rounded to a nearest integer value on the 1-K scale.

At S210, a target training document in the target language is created for each source training document, based on the translated sentences.

One or several human annotators annotate the quality of translation of each pair of source/target training documents, e.g., with an integer score from 1-K, which can be the same ordinal scale as is used by the QE component for the sentences (although any suitable range of values can be used). The annotators may be people who are bilingual in the source and target languages, and may also be knowledgeable on the topic covered by the documents. At S212, the annotations 66, 68, 70 are received by the learning component 22.

In one embodiment, each training document 60, 62, 64, etc. is assigned a single (only one) translation quality score, based on the scores assigned by the annotators. In other embodiments, the manual quality estimates are in two or more dimensions, such as fluency and adequacy. These may be combined to generate a single value or a separate aggregation function may be learned for each dimension.

At S214, based on the document pair annotations received at S212 and the SQE value associated with each translated sentence composing each of the documents, parameters of an aggregation function or classifier are automatically learned that will predict the quality of translation (DQE) of a whole document, based on predicted translation quality (SQEs) of the translated sentences of which it is composed.

At S216, the learned aggregation function (or classifier) is stored in memory.

The method then proceeds to S104.

In the case of an aggregating function being learned at S214, it is intended to aggregate a variable number of sentence SQE values into a single document DQE value. It is also intended to mimic the human annotator's judgment. Similarly, for a classifier model, the scores output by the classifier are intended to mimic the human annotator's judgment

### 1. Weighted Generalized Mean Approach

In one exemplary embodiment, a parametric aggregation function is used and the object of the training (S102) is to learn the parameters (weights and exponent), using the annotated documents obtained in S212, which should be applied by the aggregating function to the sentence SQE values of an input document.

In one exemplary embodiment, the aggregating function used to compute the document DQE at S110 is a weighted generalized mean function. The weighted generalized mean is defined as follows:

It is assumed that the sentence-level SQE scores for a given document form a set of positive real numbers x₁, . . . , x_{q}, where q is the number of sentences in the document and is variable.

Let p be an exponent for the generalized mean, selected from −∞<p<+∞.

When p is a non-zero real number, the weighted generalized mean Mₚ, with exponent p, of the positive real numbers x₁, . . . , x_{q}, is defined as:

$${M}_{p} ( {x}_{1} , … , {x}_{q} ) = {( {\sum }_{i = 1}^{q} {{w}_{i} ( {x}_{i} )}^{p} )}^{\frac{1}{p}} \qquad ( 1 )$$

where each wᵢ is a respective weight, with the weights being normalized, e.g., such that the sum of the weights Σwᵢ=1.

In the case of p=0, it is assumed that this function is equal to the geometric mean M₀ (which is the limit of means with exponents approaching zero):

M₀(x₁, . . . ,x_{q})=Πᵢ₌₁^{q}(xᵢ)^{w}^{₁} (2)

i.e., the product of all the SQEs, each raised to the power of their respective normalized weights.

While an unweighted mean could be generated by setting all the wᵢ=1/q, in the exemplary embodiment, not all weights are the same.

Additionally, while p can theoretically assume any value, up to +∞, very high (and very low) values are not very useful in the present method, since the means are then maximum and minimum, respectively, regardless of weights (as they are the limit points for exponents approaching the respective extremes):

M_{∞}(x₁, . . . ,x_{q})=max(x₁, . . . ,x_{q}) and

M_{-∞}(x₁, . . . ,x_{q})=(x₁, . . . ,x_{q})

As p becomes larger, greater importance is placed on larger SQE, while as p becomes smaller, smaller SQEs are favored. Accordingly, in one embodiment, p≦±1000, or ≦+100, such as in the range −10 to +10.

In the exemplary embodiment, the weights wᵢ are not dependent on the position i in the series but rather on the value xᵢ with which the respective weights are associated. In the exemplary embodiment, each weight is a learned function of the value xᵢ:

$${w}_{i} = \frac{QE\_weight ( {x}_{i} )}{{Σ}_{i} QE\_weight ( {x}_{i} )}$$

where the QE_weight is a mapping from a sentence SQE value to a respective weight, which is learned, together with p, in the training phase (S102). The learned QE_weight value is normalized by dividing it by the sum of the QE_weights for the document.

This weighting enables assigning more or less importance to certain SQE values when aggregating the sentence SQE values over a document. For example, a high importance could be given to a sentence that received a low SQE score (indicating a poor translation quality) by mapping the SQE score 1 to a higher weight than, for example, an SQE of 3 (indicating an acceptable translation quality). The exemplary mapping function assigns a respective weight to each possible SQE score.

As one example, suppose the possible SQE values (after rounding if not on an integer scale) are the integers (1, 2, 3, 4) and that these are mapped to QE_weights (3, 1, 1, 2), respectively. Suppose then that the computed SQE values for five sentences of a new document (after rounding, if needed) are (1, 3, 2, 2, 4). These would be mapped to QE_weights (3, 1, 1, 1, 2), and the corresponding set of weights wᵢ for computing the generalized mean would then be (0.375, 0.125, 0.125, 0.125, 0.25), after normalizing the weights.

Using training documents that are manually labeled with document-level translation quality scores, the exemplary training method (S102) entails finding an optimal p and a QE_weight mapping (S214), given the annotated data.

It is generally not necessary to use sophisticated optimization method, since an exploration of the full search space (e.g., through a grid search) remains tractable because the space can be relatively small. As an example, from 2 to 10 different values of p can be explored in combination with a limited set of weights, such as four weights (e.g., the same number of weights as there are SQE scores. For example, when p is selected from {−1, 0, 1, 2} and each (un-normalized) wᵢ is selected from {1, 2, 3} (i.e., 324 models to test), a full exploration takes a few seconds or less. While integer values of p are considered in the exemplary embodiment, it is contemplated that floating point values of p could also be used, such as 1.5. Then, for each value of p and each possible combination of weights for the possible SQE scores, a measure of accuracy is computed using the documents in the training set. Given the computed accuracy measures, a model (a weight corresponding to each possible SQE score and p) having a high (e.g., highest) accuracy can be selected and stored in memory.

At test time (S110), when the translation quality a new document is to be predicted, the stored weight mappings are used to map the computed SQE for each of the target sentences of the target document to a respective weight, the weights are normalized, and then the normalized weights and stored value of p are used compute the generalized mean according to Eqn. 1 (or Eqn. 2 if p=0). The computed value of the generalized mean can then be compared to a stored threshold value of the generalized mean at S112. The threshold can be set depending on the desired level of translation quality. For example, for translating a customer's document into the language used by an agent working for the client, it may not be necessary to ensure a high translation quality, only sufficient for the agent to understand the message, while for sending a message back to the client, a higher quality may be desired.

The measure of accuracy used to evaluate the candidate models is a function of the agreement between Mₚ (or M₀ when p=0) and the manual translation quality labels for the documents (e.g., after rounding Mₚ to the nearest integer value). For example, the “exact accuracy” may be the proportion (or percentage) of documents for which the model correctly predicted the manual translation quality value of the document. Another accuracy measure which can be used is the “conservative accuracy.” This measure is the proportion (or percentage) of documents for which the model predicted a value less or equal to the manual quality value of the document. This measure promotes an under-estimation of the document DQE value to avoid situations where a bad translation is predicted as being good. On its own, however, it is not useful for finding the optimal parameters, since the min function would then be best (which corresponds to p tending to minus infinity), although it could be used to select from a set of models having a high exact accuracy.

Optionally, regularization of the model can take the form of a second order of magnitude cost function computed as the sum of mapped QE_weights. As an example, an accuracy-based score for a set of weights wᵢ and exponent p can thus be of the form:

$$Accuracy Score ( {w}_{i} , p ) = Accuracy ( {w}_{i} , p ) - λ \frac{Σ {w}_{i}}{100}$$

where Accuracy(wᵢ, p) can be the exact accuracy and is in the range [0, 100]. λ is an optional regularization parameter which can be used to place more or less weight on the regularization term. This method of computing the accuracy score favors models in which the weights wᵢ are lower. Any other regularization term which increases as the weights increase may alternatively be used.

N-fold validation can be used to help avoiding over-fitting of the training data, which could lead to high values of the weights and p. In this embodiment, the test set is divided into folds, such as five folds, and each fold is then used as a test set with remaining folds being used as the training set. The average accuracy of the N folds is then computed.

1. Classification Based on n-Grams

In another embodiment, the parameters learned at S102 are parameters of a logistic regression function or other classifier function. In this embodiment, a classifier 16 is trained to predict the document translation quality. Since the number of sentences in a document, such as a message is variable, as features for the classifier, counts of n-grams (e.g., bigrams) formed by consecutive sentence SQE values are used. For example, if the computed SQE values for a sequence of five sentences forming a document are 1, 2, 1, 2, 2, the following bigrams are extracted (1, 2), (2, 1), (1, 2), (2, 2), i.e., the bigram (1, 2) appears twice and the other two only once. A feature vector can then be generated in which each index represents one of the possible bigrams and its value is based on the number (optionally normalized) of its occurrences in the document.

In S102, rather than learning an aggregating function, a classifier is trained to predict a document-level DQE value based on bigram features derived from sentence-level SQE scores and manually applied document-level translation quality scores. This includes, for each of a set of annotated training documents, computing an SQE for each sentence of the training document. Usual classification learning techniques can then be applied. In particular, a classifier model is learned using bigram-based feature vectors and respective manually-applied document translation quality values for a set of training documents as training data. The classifier may be a linear classifier. Suitable supervised classifier learning methods include logistic regression, support vector machines, linear regression, neural networks, Naive Bayes, and the like. Once the classifier model has been trained, it can be used to predict a DQE for a new document, based on its computed feature vector. The training learns parameters of the classifier such that, given a set of SQEs for a new document, the feature vector derived from them can be input to the classifier to output the document's DQE.

At S110, features are extracted which are a function of the sentence-level SQEs for the document, in the same manner as for the classifier training, and input to the trained classifier, which predicts a document-level DQE based thereon.

The method then proceeds to S112.

In more detail, the feature vector representing a document of N sentences can be computed as follows:

For each sentence that is translated, its translation quality SQE on a 1-K integer scale is obtained as discussed above (where K may be, for example 4 or 5). Then, a sequence of the sentences SQE is generated. It can be prefixed by a unique BEGIN symbol and suffixed by a unique END symbol. The sequence length is then N+2. This sequence is then represented by the corresponding set of bigrams and a count of each bigram used to generate a bigram histogram. The bigram histogram can be used as a basis of the feature vector. The dimensionality of the feature vector is 2·K+K² (2·K of the bigrams are due to the BEGIN and END symbols). This gives 8 features for a K=2 (binary scale) and 24 features for a K=4 (1-4 scale).

In an exemplary embodiment, the histogram bins are normalized. For example, a Gaussian normalization is used, such that each feature is a real number in the range [−1, 1]. The histogram characterizes the N+1 possible bigrams.

In some embodiments, more than one method is used to compute the DQE, such as the generalized mean and bigram feature classifier methods described above, Then the two (or more) DQE scores are aggregated, e.g., as a simple sum, average, or weighted sum/average.

### Machine Translation

As the machine translation component 12, any suitable machine translation system can be used. An example machine translation system 12 includes a decoder which, given a source sentence, draws biphrases (source-target phrase pairs) from the phrase table 52 such that each word in the target sentence is covered by no more than one biphrase, thereby generating a candidate translation of the sentence or a part of the sentence from the target side of each of the biphrases used. The phrase table stores corpus statistics for a set of biphrases found in a parallel training corpus. Candidate translations generated in this way are scored with a translation scoring function to identify the most probable translation from a set of the candidate translations in the target natural language. The translation scoring function may be a log-linear function which sums a weighted set of features, some of which are derived from the corpus statistics for the biphrases retrieved from the phrase table, such as forward and reverse phrase and lexical translation probabilities. Other features may include language model, word penalty, and reordering features. See, for example, U.S. Pub. No. 20070150257, Christoph Tillmann and Fei Xia, “A Phrase-Based Unigram Model For Statistical Machine Translation,” in Proc. HLT-NAACL 2003 Conf., Edmonton, Canada (2003), and Richard Zens and Hermann Ney, “Improvements in Phrase-Based Statistical Machine Translation,” Proc. Conf. HLT-NAACL, pp. 257-264 (2004) for example scoring functions. An example machine translation system is a MOSES-based translation system.

Phrase based machine translation systems are disclosed, for example, in U.S. Pat. Nos. 6,182,026 and 8,543,563; U.S. Pub. Nos. 20040024581; 20040030551; 20060190241; 20070150257; 20070265825, 20080300857; 20110022380; 20110178791; 20110282643; 20110288852; 20110307245; 20120041753; 20120101804; 20120259807; 20120278060; 20130006954; 20140067361; and U.S. application Ser. No. 13/740,508, filed Jan. 14, 2013, entitled MULTI-DOMAIN MACHINE TRANSLATION MODEL ADAPTATION by Markos Mylonakis, et al. Language models, which can be used as a feature of the translation scoring function, are described, for example, in U.S. Pub. No. 20120278060. Methods for building libraries of parallel corpora from which phrase tables can be generated are disclosed, for example, in U.S. Pub. Nos. 20080262826 and 20100268527. The disclosures of all of these references are incorporated herein by reference in their entireties.

### Translation Quality Estimation for Sentences (S108, S208)

Machine translation quality estimation involves predicting a quality score for a machine-translated sentence without access to any reference translations. Any suitable method for estimating sentence-level translation quality can be used herein. Examples include the methods of Blatz 2004 and Specia 2009 for determining CE scores, mentioned above. Currently, the most common approach is to treat the problem as a supervised machine learning task, using standard regression or classification algorithms and features extracted for the source and target sentences. See, for example, Bojar, et al., “Findings of the 2013 workshop on statistical machine translation,” Proc. 8^{th} Workshop on Statistical Machine Translation, pp. 1-44 (2013); Cohn, et al., “Modelling annotator bias with multi-task Gaussian processes: An application to machine translation quality estimation,” Proc. 51st Annual Meeting of the ACL, pp. 32-42 (2013).

The QE component 14 can use any suitable set of features for determining translation quality. Some of the features may be MT system-dependent (glass box) features, provided that the QE system has access to the operation of the SMT component 12. Some of the features can be MT-independent (black box) features. A combination of glass box and black box features may be used. Examples of such features are described in Specia, et al. “Deliverable D2.1.2 Quality Estimation Software Extensions,” pp. 1-31 (October 2013), available at http://www.qt21.eu/launchpad/system/files/deliverables/qtlp-deliverable-d2.1.2.pdf. Some or all of these features may be used in the present method, although additional or different features may also be employed.

Examples of glass box features, which are suited to use with a Moses statistical machine translation system, employ internal information from Moses, such as: n-best list with up to n translations for each source sentence, the phrase table (model) feature values for them (translation model scores, language model score, distortion scores, etc.), final model score, phrase and word-alignment, decoder word graph, and information from the decoder regarding the search space (number of nodes in search graph, number of nodes pruned, etc.). From these resources, various features can be extracted, such as one or more of: log probability score of the hypothesis (Moses' global score), which may be normalized by source sentence length; size of n-best list (number of hypotheses generated); for a LM built from the n-best list, the sentence n-gram log probabilities and perplexities (where n can be from 1-3), optionally normalized by sentence length; each of the translation and language model feature values (such as features based on forward and backward lexical probabilities, phrasal probabilities, distortion, and reordering); maximum size of the biphrases (number of words) used in the translation; proportion of unknown/untranslated words; average relative frequency of words in the translation across the n-best list (optionally score-weighted); average relative frequency of the words in the translation across the n-best list occurring in the same position as a respective target word; average size of hypotheses in the n-best list; n-best list density (vocabulary size/average sentence length); fertility of the words in the source sentence compared to the n-best list in terms of words (vocabulary size/source sentence length); edit distance of the current hypothesis to the center hypothesis (closest hypothesis to all others in the n-best list); total number of hypotheses in search graph; number/percentage of discarded/pruned/recombined search graph nodes; percentage of incorrectly translated possessive pronouns; percentage of incorrectly translated direct object personal pronouns.

Exemplary black-box features include those that rely on word counts, word-alignment information, part-of-speech (POS) tagging, features that represent linguistic phenomena that are only relevant for certain language pairs, and the like. Some or all of the following may be used: number of tokens in source (or target); ratio of number of tokens in source to target (or vice versa); absolute difference between number of tokens in source and target, which may be normalized by source length; average source token length; number of mismatched brackets (opening brackets without closing brackets, and vice versa); number of mismatched quotation marks (opening marks without closing marks, and vice versa); source sentence LM probability; source (or target) sentence LM perplexity; source (or target) sentence LM probability; number of occurrences of the target word within the target hypothesis (averaged for all words in the hypothesis-type/token ratio); average number of translations per source word in the sentence in the phrase table or with a given threshold probability in the source corpus, optionally weighted by the frequency (or inverse frequency) of each word in the source corpus; average unigram (or bigram or trigram) frequency in quartile 1 (or 2, 3, or 4) of frequency (lower frequency words) in the corpus of the source language; percentage of distinct source unigrams (or bigrams, or trigrams) seen in a corpus of the source language (in all quartiles); average word frequency that each word in the source sentence appears in the corpus (in all quartiles); absolute difference between number of periods (or commas, colons, semicolons, question marks, or exclamation marks), in source and target sentences, optionally normalized by target length; absolute difference between number of commas in source and target sentences, optionally normalized by target length; percentage of punctuation marks in source (or target) sentence; absolute difference between number of punctuation marks between source and target sentences normalized by target length; percentage of numbers in the source (or target) sentence; absolute difference between number of numbers in the source and target sentences, normalized by source sentence length; number of tokens in the source (or target) sentence that do not contain only a-z; ratio of number/percentage tokens containing only a-z in the source to that in the target sentence; percentage of content words in the source (or target) sentence; ratio of percentage of content words in the source and target; LM probability of POS tags of target sentence; LM perplexity of POS tags of target sentence; percentage of nouns (or verbs or pronouns) in the source (or target) sentence; ratio of percentage of nouns or (or verbs, or pronouns) in the source and target sentences; number of dependency relations with aligned constituents, normalized by the total number of dependencies (max between source and target sentences), optionally with the order of the constituents ignored; number of dependency relations with possibly aligned constituents (using Giza's lexical table with p>0.1) normalized by the total number of dependencies (max between source and target sentences); absolute difference between the depth of the syntactic trees of the source and target sentences; number of prepositional phrases (PP) (or noun phrases (NP), or verbal phrases (VP), or adjectival phrases (ADJP) or adverbial phrases (ADVP), or conjunctive phrases (CONJP)) in the source (or target) sentence; absolute difference between the number of PP (or NP, VP, ADJP, ADVP, or CONJP) phrases in the source and target sentences, optionally normalized by the total number of phrasal tags in the source sentence; geometric mean (lambda-smoothed) of 1-to-4-gram precision scores of target translation against a pseudo-reference produced by a second MT system; source probabilistic context-free grammar (PCFG) parse log-likelihood; source PCFG average confidence of all possible parses in n-best list; source PCFG confidence of best parse; count of possible source PCFG parses; target PCFG parse log-likelihood; target PCFG average confidence of all possible parses in n-best list of parse trees for the sentence; target PCFG confidence of best parse; count of possible target PCFG parses; Kullback-Leibler (or Jensen-Shannon) divergence of source and target topic distributions; divergence of source and target topic distributions; source sentence intra-lingual triggers; target sentence intra-lingual triggers; source-target sentence inter-lingual mutual information, percentage of incorrectly translated possessive pronouns (or direct object personal pronouns) (for Arabic-English only); Information retrieval (IR) features that measure the closeness of the test source sentences and their translations to parallel training data available to predict the difficulty of translating each sentence or finding their translations; IR score for each training instance retrieved for the source sentence or its translation; and combinations thereof.

The method illustrated in one or more of FIGS. 2-3 may be implemented in a computer program product that may be executed on a computer. The computer program product may comprise a non-transitory computer-readable recording medium on which a control program is recorded (stored), such as a disk, hard drive, or the like. Common forms of non-transitory computer-readable media include, for example, floppy disks, flexible disks, hard disks, magnetic tape, or any other magnetic storage medium, CD-ROM, DVD, or any other optical medium, a RAM, a PROM, an EPROM, a FLASH-EPROM, or other memory chip or cartridge, or any other non-transitory medium from which a computer can read and use.

Alternatively, the method may be implemented in transitory media, such as a transmittable carrier wave in which the control program is embodied as a data signal using transmission media, such as acoustic or light waves, such as those generated during radio wave and infrared data communications, and the like.

The exemplary method may be implemented on one or more general purpose computers, special purpose computer(s), a programmed microprocessor or microcontroller and peripheral integrated circuit elements, an ASIC or other integrated circuit, a digital signal processor, a hardwired electronic or logic circuit such as a discrete element circuit, a programmable logic device such as a PLD, PLA, FPGA, Graphical card CPU (GPU), or PAL, or the like. In general, any device, capable of implementing a finite state machine that is in turn capable of implementing the flowchart shown in one or more of FIGS. 2-3, can be used to implement the method for predicting document translation quality. As will be appreciated, while the steps of the method may all be computer implemented, in some embodiments one or more of the steps may be at least partially performed manually.

Without intending to limit the scope of the exemplary embodiment, the following Examples describe a prototype system for performing the method shown in FIGS. 2 and 3.

### Examples

A prototype system was developed. The goal of the system was to assess the quality of translation between Swedish and English, in both directions, for email messages being sent between a client and its customers.

Two SMT models (Swedish-English and English-Swedish) were used. 53 Swedish messages and 28 English messages were selected (186 Swedish sentences in total and 179 English sentences in total). A bilingual person evaluated the quality of translation of each message as a whole and then evaluated the quality of translation of each sentence. The bilingual person used a 1-4 scale along two dimensions: fluency and adequacy.

The scale is explained in Table 1 below:

TABLE 1

| Fluency | | Adequacy | |
|---|---|---|---|
| 1 | Incomprehensible | 1 | Different or no meaning |
| 2 | Bad or disfluent language | 2 | Little meaning |
| 3 | Imperfect or non-native language | 3 | Most meaning |
| 4 | Fluent language | 4 | All meaning |

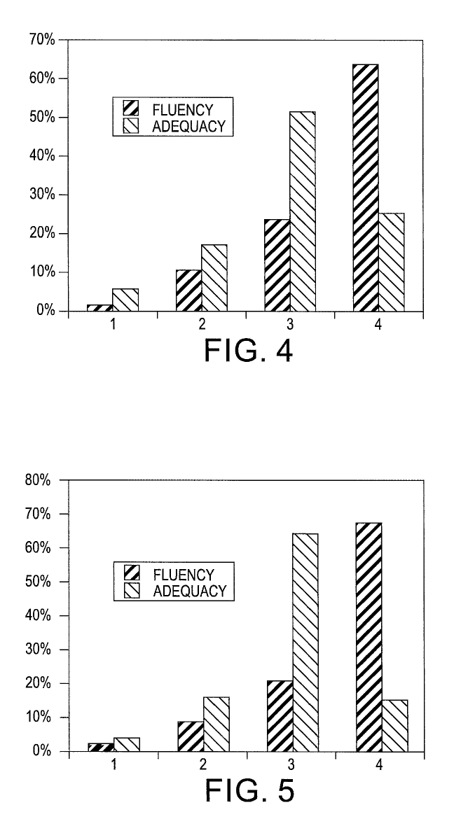

The histograms shown in FIGS. 4 and 5 illustrate the result of the human evaluation, on Swedish to English and English to Swedish. In both directions, fluency and adequacy are highly correlated, at respectively 0.86 and 0.90.

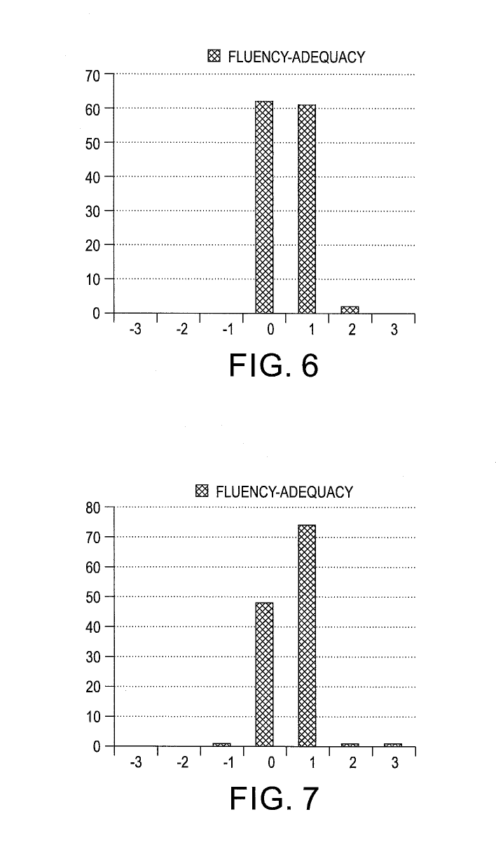

The histograms shown in FIGS. 6 and 7 illustrate the frequency of the numerical difference between fluency and adequacy from FIGS. 4 and 5. These illustrate there is only a slight difference between the two scoring methods. For simplicity therefore, in the following, focus was placed on predicting the adequacy, since fluency is above it in 99% of the cases.

The method of FIG. 3 was used to generate an aggregating function. As a QE function was not available for the initial tests, a manually-annotated QE value for each sentence was used, rather than an automatically-generated SQE value.

As a baseline for computing the generalized mean according to Eqn. 1 and 2, when all weights were fixed to 1 (all SQE values have equal importance) and p values of: −100, −1, 0, 1, 2, 3, 100, results as shown in TABLE 2 were obtained.

TABLE 2
Baseline

| | | | | | Mapping |
|---|---|---|---|---|---|
| Exact | Conservative | Avg | Avg Abs | | weights for |
| Accuracy | Accuracy | Error | Error | p | K = 1, 2, 3, 4 |
| 60.49% | 69.14% | 0.23 | 0.46 | 2 | 1, 1, 1, 1 |
| 59.26% | 70.37% | 0.19 | 0.46 | 1 | 1, 1, 1, 1 |
| 58.02% | 62.96% | 0.33 | 0.48 | 3 | 1, 1, 1, 1 |
| 55.56% | 75.31% | 0.02 | 0.47 | 0 | 1, 1, 1, 1 |
| 51.85% | 77.78% | 0.07 | 0.52 | −1 | 1, 1, 1, 1 |
| 37.04% | 92.59% | −0.69 | 0.84 | −100 | 1, 1, 1, 1 |
| 22.22% | 27.16% | 0.85 | 1.00 | 100 | 1, 1, 1, 1 |

In this case, the highest exact accuracy obtained was about 60%. Average error is the difference between prediction and true value, averaged over all messages. Average absolute error is the average error computed ignoring the sign of the errors.

In a second experiment, the space defined by p in the range [−1, 3] and the weights in the range [1, 3], 405 models were scored very quickly. A selection of the results is shown in TABLE 3.

TABLE 3
Variable Weights

| | | | | | Mapping of |
|---|---|---|---|---|---|
| Exact | Conservative | Avg | Avg Abs | | weights for |
| Accuracy | Accuracy | Error | Error | p | K = 1, 2, 3, 4 |
| 65.43% | 79.01% | 0.06 | 0.38 | 0 | 1, 1, 3, 1 |
| 64.20% | 80.25% | 0.02 | 0.40 | 0 | 1, 2, 3, 1 |
| 64.20% | 77.78% | 0.07 | 0.40 | 2 | 3, 2, 3, 1 |
| 64.20% | 81.48% | 0.00 | 0.40 | 1 | 2, 3, 3, 1 |
| 62.96% | 75.31% | 0.10 | 0.42 | 0 | 1, 2, 1, 2 |
| 62.96% | 76.54% | 0.10 | 0.42 | −1 | 2, 1, 3, 1 |
| 62.96% | 75.31% | 0.10 | 0.42 | 1 | 2, 3, 1, 2 |
| 62.96% | 79.01% | 0.04 | 0.41 | 1 | 2, 2, 3, 1 |
| 61.73% | 82.72% | −0.07 | 0.44 | 0 | 2, 1, 3, 1 |
| 61.73% | 74.07% | 0.11 | 0.43 | 3 | 3, 3, 1, 1 |
| 61.73% | 83.95% | −0.09 | 0.43 | 0 | 2, 2, 3, 1 |
| . | | | | | |
| . | | | | | |
| . | | | | | |
| 59.26% | 70.37% | 0.19 | 0.46 | 1 | 1, 1, 1, 1 |
| . | | | | | |
| . | | | | | |
| . | | | | | |
| 40.74% | 82.72% | −0.37 | 0.72 | −1 | 3, 3, 1, 1 |
| 39.51% | 44.44% | 0.59 | 0.74 | 3 | 1, 1, 1, 3 |

In TABLE 3, the ranking for models with the same accuracy is based on the accuracy minus the sum of weights, so the model for p=0 with mapped weights=(1, 2, 3, 1) is ranked above the model for p=2 with mapped weights=(3, 2, 3, 1) (simulating the use of a regularization term).

The results of this prototype method suggest that an optimal set of parameters is p=0 (the geometric mean) with all SQE values having a weight 1.0 except an SQE-value of 3, which has weight of 3.0.

In a subsequent test, when an automated QE component 14 had been developed, the results on the training data used suggested the optimal set of parameters, from those tested, was a value of p=−5 and weights for the SQE values (1, 2, 3, 4) of (3, 1, 1, 1).

An initial experiment with a binary logistic regression suggests that the classifier method approach was not as good as the approach using the generalized mean in binary mode (only 2 quality scores).

The results suggest that the quality of translation of a whole message can be predicted, based on the predicted quality of its sentences.

It will be appreciated that variants of the above-disclosed and other features and functions, or alternatives thereof, may be combined into many other different systems or applications. Various presently unforeseen or unanticipated alternatives, modifications, variations or improvements therein may be subsequently made by those skilled in the art which are also intended to be encompassed by the following claims.

What is claimed is:

1. A method for predicting the translation quality of a document comprising:
receiving a translation quality estimate for each of a plurality of sentences of an input document which have been translated from a source language to a target language using machine translation;
with a processor, predicting the translation quality of the translated input document based on the translation quality estimate for each of the sentences and parameters of a model learned using translation quality estimates for sentences of training documents and respective manually-applied translation quality values.

2. The method of claim 1, wherein the predicting includes computing a generalized mean function based on the translation quality estimates and wherein the model parameters include parameters for mapping translation quality estimates to respective weights to be applied to the translation quality estimates in computing the generalized mean function.

3. The method of claim 1, wherein the model parameters include an exponent for the generalized mean function.

4. The method of claim 3, wherein when the exponent is non-zero, the generalized mean function is of the form:
$${M}_{p} ( {x}_{1} , … , {x}_{q} ) = {( {\sum }_{i = 1}^{q} {{w}_{i} ( {x}_{i} )}^{p} )}^{\frac{1}{p}} , \qquad ( 1 )$$
and
when p is zero, the generalized mean function is of the form:
M₀(x₁, . . . ,x_{q})=Πᵢ₌₁^{q}(xᵢ)^{w}^{ᵢ} (2)
where q is the number of sentences in the document;
x₁, . . . , x_{q} represent the translation quality estimates for the sentences in the document;
p is the exponent;
each wᵢ represents the normalized weight for the respective translation quality estimate xᵢ.

5. The method of claim 4, where p is non-zero.

6. The method of claim 4, where p is in a range of from −100 to +100.

7. The method of claim 4, wherein in computing the generalized mean, the weights in the model are normalized such that
$${w}_{i} = \frac{QE\_weight ( {x}_{i} )}{{Σ}_{i} QE\_weight ( {x}_{i} )} ,$$
where QE_weight(xᵢ) is the weight in the model assigned to translation quality estimate xᵢ.

8. The method of claim 1, wherein the model parameters include weights and an exponent for an aggregating function which aggregates the sentence translation quality estimates.

9. The method of claim 1, further comprising comparing the translation quality estimate for the input document with a threshold to determine whether the document meets the threshold.

10. The method of claim 9, wherein when the document meets the threshold, outputting the translation of the document.

11. The method of claim 1, further comprising learning the model.

12. The method of claim 11, wherein the learning of the model includes computing a measure of accuracy for each of a set of models comprising for each model and for each of the training documents, computing a generalized mean using the respective model parameters and comparing the computed generalized mean with a respective manually-applied translation quality value for the document, the measure of accuracy being based on the comparison, and selecting an optimal one of the models based on the computed accuracy.

13. The method of claim 2, wherein for each model, the model parameters include weights for each of a set of translation quality values and wherein measure of accuracy takes into account a sum of the weights.

14. The method of claim 1, wherein the manually-applied translation quality values are selected from a finite set of from 2-10 translation quality values.

15. The method of claim 1, wherein the model comprises a classifier trained on feature vectors that are based on occurrence of consecutive translation quality estimates when considering each training document as a sequence of the translation quality estimates of its constituent sentences and wherein the predicting includes computing a feature vector for the input document and generating the document quality estimate with the trained classifier based on the feature vector for the input document.

16. A computer program product comprising a non-transitory recording medium storing instructions, which when executed on a computer causes the computer to perform the method of claim 1.

17. A system for predicting the translation quality of a document comprising memory which stores instructions for performing the method of claim 1 and a processor in communication with the memory which executes the instructions.

18. A system for predicting the translation quality of a document comprising:
a machine translation component for translating sentences of an input document from a source language to a target language;
a quality estimation component for estimating translation quality of each of the translated sentences;
a prediction component for predicting the translation quality of the translated document based on the translation quality estimates for the sentences and parameters of a model learned using translation quality estimates for sentences of training documents and respective manually-applied translation quality values; and
a processor which implements the machine translation component, quality estimation component, and prediction component.

19. The system of claim 18, further comprising a learning component for learning parameters of the model.

20. A method for predicting the translation quality of a document comprising:
receiving an input document in a source language comprising a plurality of sentences;
translating the sentences of the input document from the source language to a target language to generate a translated document;
estimating a translation quality of each of the translated sentences in the translated document; and
predicting the translation quality of the translated document based on the translation quality estimates for the translated sentences, comprising computing an aggregating function for which translation quality estimates are weighted with weights and wherein the weights and an exponent for the aggregating function have been learned using translation quality estimates for sentences of training documents and a respective manually-applied translation quality value of the training document,
wherein at least one of the translating, estimating, and predicting is performed with a processor.
